(19) United States
(12) Patent Application Publication
(10) Pub. No.: US 2002/0095689 A1
(43) Pub. Date: Jul. 18, 2002

(54) Hardware decoding of media streams from multiple sources

(76) Inventor: Robert E. Novak, Kirkland, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/851,361

(22) Filed: May 8, 2001

Related U.S. Application Data
(60) Provisional application No. 60/261,676, filed on Jan. 12, 2001.

(51) Int. Cl. H04N 7/173; H04N 7/16

(52) U.S. Cl. 725/151; 725/131; 725/111; 725/110

(57) ABSTRACT

Digital media streams are received by a cable set top box (STB) from multiple sources, such as cable television and IP (Internet Protocol) sources. The STB includes a standard video tuner and a demodulator/demultiplexer for receiving an encoded media stream from a cable television source. In addition, the STB includes a modem device and CPU for receiving an encoded media stream from an IP source. The STB further includes a stream selector, which selectively receives an encoded media stream from either (1) the video tuner and demodulator/demultiplexer or (2) the modem device and CPU, for transmission to a hardware-based decoder.

### RELATED APPLICATION

The present application is related to and claims priority from U.S. Patent Application No. 60/261,676, entitled “Hardware Decoding of MPEG Video Streams From Cable Television and Internet Sources,” filed Jan. 12, 2001, with inventor Robert E. Novak, which is incorporated herein by reference in its entirety.

### FIELD OF THE INVENTION

The present invention relates generally to decoding of digital media streams. More specifically, the present invention relates to hardware decoding of digital media streams from multiple sources, such as cable television and Internet sources.

### DESCRIPTION OF THE BACKGROUND ART

In the context of a cable television network, a set top box (STB) is a device that selectively receives and decodes television signals for display on a television or other display device. In general, an STB includes a video tuner for receiving television signals on a selected frequency (e.g., channel). Often, the signals are encoded to limit access to legitimate subscribers using a technique called conditional access (CA). Thus, an STB also typically includes hardware and software for decoding or decrypting the signals when the subscriber is authorized to receive them.

Advances in signal encoding have led to the use of digital compression techniques for delivering television programs via a cable television network. Digital compression increases channel capacity over existing cable infrastructures and improves video and audio quality. The most common digital compression format is MPEG (Moving Picture Experts Group), variants of which include MPEG-1, MPEG-2, MPEG-4, MPEG-7, and the like.

In recent years, a new generation of “digital” STBs has emerged for receiving digitally-compressed video and audio streams, referred to herein as “media” streams. Typically, these new digital STBs include a modem device, such as a Data Over Cable Service Interface Specification (DOCSIS) cable modem. The modem device facilitates Internet access, including Web browsing and e-mail, as well as other advanced features, such as Video-on-Demand (VoD).

Today, media streams are available from many different sources. For example, a digital STB may receive media streams including television programming from one or more cable television sources. Increasingly, media streams are also becoming available from Internet Protocol (IP) sources, such as Internet-based servers.

Conventional STBs include hardware decoders for decoding media streams received from cable television sources. Hardware decoders provide relatively high frame rates when compared to software decoding by general purpose microprocessors.

Unfortunately, due to architectural limitations, media streams received from IP sources cannot be decoded by a hardware decoder of a conventional STB. For example, as shown in FIG. 1, a conventional STB is typically configured with separate decoding paths for media streams received from cable television sources (e.g., via a video tuner) and for media streams received from IP sources (e.g., via a modem device). Thus, an IP-based media stream must be decoded using software decoding, which limits the frame rate of the displayed media stream and burdens the STB's CPU.

Accordingly, what is needed is an architecture for a digital STB that allows for hardware decoding of media streams from multiple sources, such as cable television sources and IP sources.

### BRIEF DESCRIPTION OF THE DRAWINGS

Non-exhaustive embodiments of the invention are described with reference to the figures, in which:

FIG. 1 is a block diagram of a standard set top box (STB);

FIG. 2 is a block diagram of a communication network;

FIG. 3 is a block diagram an STB according to one embodiment of the invention;

FIG. 4 is a block diagram of an alternative embodiment of an STB;

FIG. 5 is a block diagram of a companion device for interfacing with a standard STB to provide enhanced functionality;

FIG. 6 is a block diagram of an alternative embodiment of a companion device; and

FIG. 7 is a block diagram of an alternative embodiment of a set top box including multiple hardware decoders.

### DETAILED DESCRIPTION OF THE PREFERRED EMBODIMENTS

Digital media streams are received by a cable set top box (STB) from multiple sources, such as cable television and IP (Internet Protocol) sources. The STB includes, in one embodiment, a standard video tuner and a demodulator/demultiplexer for receiving an encoded media stream from a cable television source. In addition, the STB includes a modem device and CPU for receiving an encoded media stream from an IP source, such as an Internet-based server.

In one configuration, the STB further includes a stream selector, which selectively receives an encoded media stream from either (1) the video tuner and demodulator/demultiplexer or (2) the modem device and CPU, for transmission to a hardware decoder. Thus, media streams from different sources may benefit from the speed and efficiency of the STB's hardware decoder, resulting in improved frame rates and lower processor overhead.

Reference throughout this specification to “one embodiment” or “an embodiment” means that a particular feature, structure, or characteristic described in connection with the embodiment is included in at least one embodiment of the present invention. Thus, the appearances of the phrases “in one embodimen” or “in an embodiment” in various places throughout this specification are not necessarily all referring to the same embodiment.

Furthermore, the particular features, structures, or characteristics may be combined in any suitable manner in one or more embodiments. In the following description, numerous specific details are provided, such as examples of software modules, user interfaces and commands, network interfaces, hardware components, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

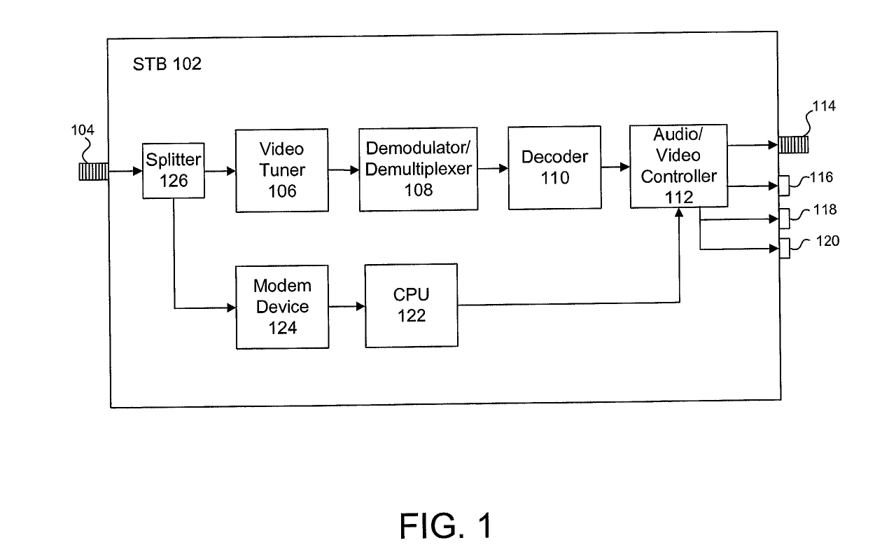

Throughout the following disclosure, the term “coupled” may be used to refer to components that are either directed connected or linked by one or more other components. Thus, as used herein, the term “coupled” may be synonymous with “in electrical communication with” or simply “in communication with.” Referring now to FIG. 1, a conventional STB 102 typically includes an RF input 104, such as cable television “F” connector, for coupling the STB 102 to a cable head-end (not shown) or other distribution node of a broadband cable network. The RF input 104 is in electrical communication with a standard video tuner 106 for selectively receiving an analog signal ranging in frequency, for example, from 50 to 860 Mhz.

The signal may include a modulated/multiplexed digital media stream, such as an MPEG (Moving Picture Experts Group) or Digicypher stream. The digital media stream may include a number of discrete audio/video “channels,” which may be selected by a user through the use of a remote control device (not shown). As used herein, the term “digital media stream” may include video and audio streams individually or collectively.

The video tuner 106 is coupled, in one implementation, to a demodulator/demultiplexer 108, which demodulates the signal and selects a particular audio/video channel for decoding by a hardware decoder 110 (such as an MPEG-2 decoder). The decoder 110 is typically a special-purpose hardware unit that is able to provide relatively high frame rates when compared to software decoding by a general-purpose microprocessor. Single-chip MPEG-2 decoders are well known and available from a number of manufacturers, such as Broadcom, C-Cube, and the like. Likewise, video tuners 106 and demodulator/demultiplexers 108 are well known and available in the art.

Of course, those skilled in the art will recognize that various other MPEG standards exist, such as MPEG-1, MPEG-4, MPEG-7 and the like. Thus, the term “MPEG,” as used herein, is intended to encompass all of the MPEG video standards. Moreover, other video encoding/compression standards exist other than MPEG, such as Digicypher, JPEG, JPEG-LS, H.261, and H.263. Accordingly, the invention should not be construed as being limited only to MPEG.

The decoder 110 is coupled, in one embodiment, to an audio/video (A/V) controller 112. The AN controller 112 provides audio/video output suitable for reception by a television or recording device, such as a VCR, DVR, or the like. The AN controller 112 preferably includes graphics hardware for performing bit-block transfers (bit-blits) as well as other graphical operations in order to display a graphical user interface (GUI) on the television. The GUI may include menus, selectable controls, and the like, and may be displayed separately or simultaneously with television content.

The AN controller 112 may be coupled to an RF output 114, such as a cable television “F” connector. In such an embodiment, the AN controller 112 includes a remodulator for generating a modulated television signal on a particular channel, typically channel 3 or 4. Alternatively, the A/V controller 112 may be coupled to a composite (RCA-type) video output 116, as well as left and right (stereo) audio outputs 118, 120. Of course, other types of outputs may be provided, such as SVideo, SPDIF, etc.

The STB 102 may also include a central processing unit (CPU) 122, such as a microprocessor, digital signal processor (DSP), or the like. The CPU 122 controls the operation of the STB 102, including the various components thereof. The CPU 122 executes software programs stored in a memory (not shown) to perform various tasks, such as displaying a GUI, processing user commands, managing a protocol stack (e.g., TCP/IP) for network communication, and the like. Although not specifically illustrated, those skilled in the art will recognize that the CPU 122 may be coupled to the decoder 110 to allow the CPU 122 to notify the decoder 110 concerning the format of the media stream to decode, e.g. MPEG-2 or MPEG-4.

Typically, the STB 102 also includes a modem device 124, coupled to the CPU 122. The modem device 124 may conform, for example, to the DOCSIS (Data Over Cable Service Interface Specification) or DAVIC (Digital Audio-Visual Council) cable modem standards, although other types of modems are contemplated. The modem device 124 demodulates an analog signal received from the broadband cable network to create a digital signal usable by other components of the STB 102. Likewise, the modem device 124 modulates a digital signal to create an analog signal for transmission to the broadband cable network. While the modem device 124 is illustrated as being disposed within STB 102, an external modem device 124 may be provided in other embodiments. The STB 102 may also include a splitter 126 for directing signals received from the broadband cable network to both the video tuner 106 and the modem device 124.

Those skilled in the art will appreciate that FIG. 1 illustrates basic components of a standard STB 102 and is not intended to be an exhaustive description thereof. Various details known to those skilled in the art have been omitted for purposes of clarity.

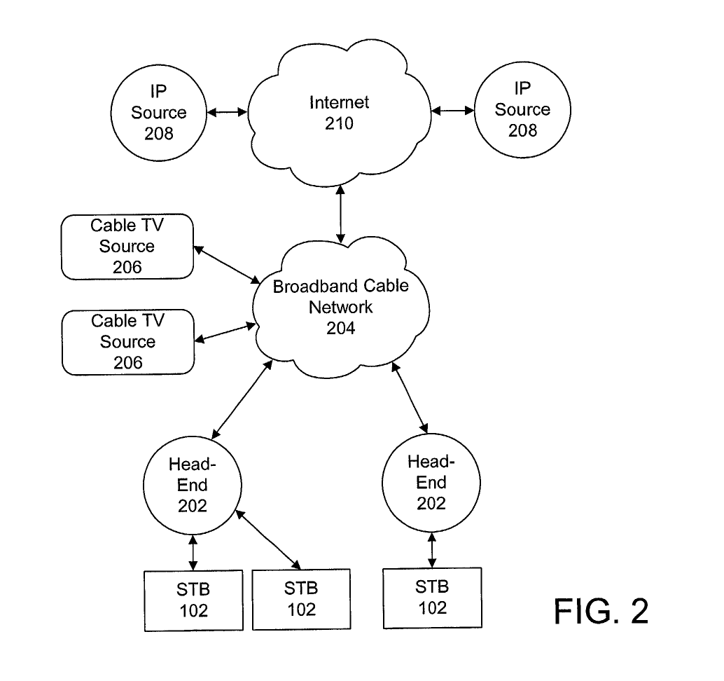

As illustrated in FIG. 2, each STB 102 may be in electrical communication with a cable head-end 202, which functions as a distribution center for a plurality of STBs 102. The cable head-ends 202 may be connected, in one embodiment, by a broadband cable network 204 or other suitable network.

As noted above, media streams may be received from a number of sources. For example, traditional cable television sources 206 provide digital media streams for a variety of television channels, pay-per-view channels, and the like. However, digital media streams are now being received from IP (Internet Protocol) sources 208 via the Internet 210. The Internet 210 is a “network of networks,” and relies on standard protocols, such as TCP/IP.

Unfortunately, the conventional STB 102 of FIG. 1 is only capable of performing software (e.g., CPU-based) decoding of digital media streams received from an IP source 208. For instance, IP packets containing a digital media stream are received by the modem device 124. The CPU 122, which typically manages the protocol stack, extracts the digital media stream from the IP packets. However, in a conventional architecture, there is no path from the CPU 122 to the decoder 110. Thus, the general-purpose CPU 122 must perform software decoding of the media stream. Typically, this results in reduced frame rates when compared to hardware decoding by the special-purpose decoder 110.

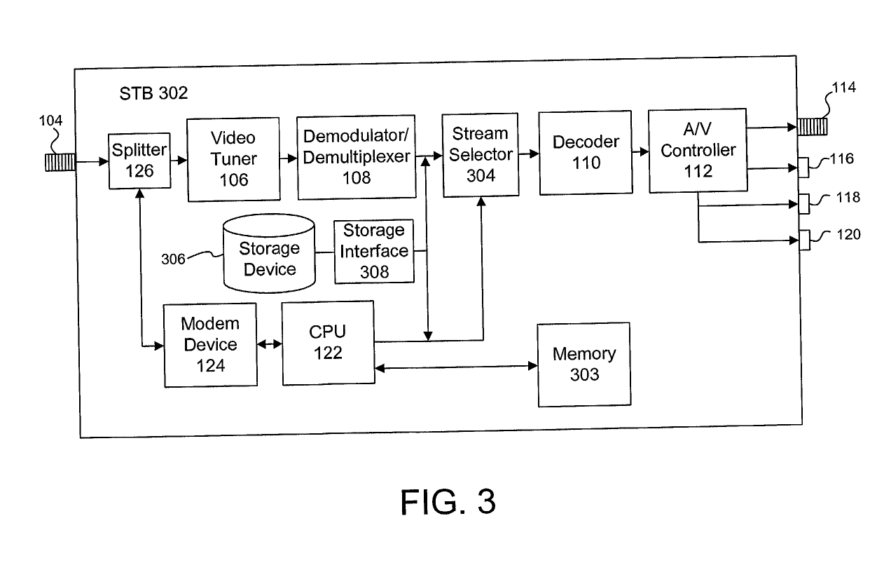

FIG. 3 illustrates an STB 302 according to an embodiment of the invention that alleviates the foregoing problem. In one configuration, the STB 302 includes a tuner 106, a demodulator/demultiplexer 108, a decoder 110, an A/V controller 112, a CPU 122, and a modem device 124, as described with reference to FIG. 1. The CPU 122 may be embodied in various forms, such as a microcontroller, microprocessor, DSP, or the like. The CPU 122 performs logical and arithmetic functions under control of software programs stored in a memory 303.

In one implementation, the STB 302 includes a stream selector 304 which selects between media streams from multiple sources, e.g., from a cable television source 206 via the video tuner 106 and from an IP source 208 via the modem device 124. The selected digital media stream is then passed to the decoder 110 for hardware decoding. In one embodiment, the selection of media streams by the stream selector 304 is controlled by the CPU 122.

In one implementation, the stream selector 304 is a multiplexer having a select line coupled to the CPU 122. The stream selector 304 may also be embodied as a combination of logic gates in an integrated circuit or the like. Alternatively, the stream selector 304 may include analog components. The stream selector 304 may also be implemented as a bus controlled by the CPU 122 with associated programming.

As an example, suppose a user desires to view a signal containing a media stream received from an IP source 208. The splitter 126 passes the signal to the modem device 124. The modem device 124 receives and demodulates the signal into a series of IP packets, from which the CPU 122 extracts a media stream. The CPU 122 passes the media stream to the stream selector 304, and signals the stream selector 304 (via a select line) to pass the media stream to the decoder 110.

Alternatively, suppose a user wishes to view a signal containing a media stream from a cable television source 206. The splitter 126 passes the signal to the video tuner 106 and demodulator/demultiplexer 108, where the digital media stream is selectively extracted from the signal. In this case, the CPU 122 signals the stream selector 304 to pass the media stream to the decoder 110.

Thus, the stream selector 304 allows the decoder 110 to selectively decode streams from multiple sources, such as cable television 206 and IP sources 208. This results in higher frame rates for IP streams and substantially reduces the processing burden on the CPU 122, allowing the CPU 122 to perform other desirable tasks.

In one implementation, a storage device 306, such as a hard disk drive, is in communication with the demodulator/demultiplexer 108 and the CPU 122 and for storage and retrieval of digital media streams obtained from cable television and IP source 208, 208, respectively. The storage device 306 may be coupled to the aforementioned components via a storage interface 308.

In one embodiment, the storage device 306 may be used to provide personal video recording (PVR) functionality, such as scheduled recording of television programs, automatic recording of television programs based on specified and observed user preferences, pausing (buffering) live video, and the like. A stored digital media stream may be retrieved from the storage device 306 by the storage interface 308 and sent to the stream selector 304 for decoding by the decoder 110.

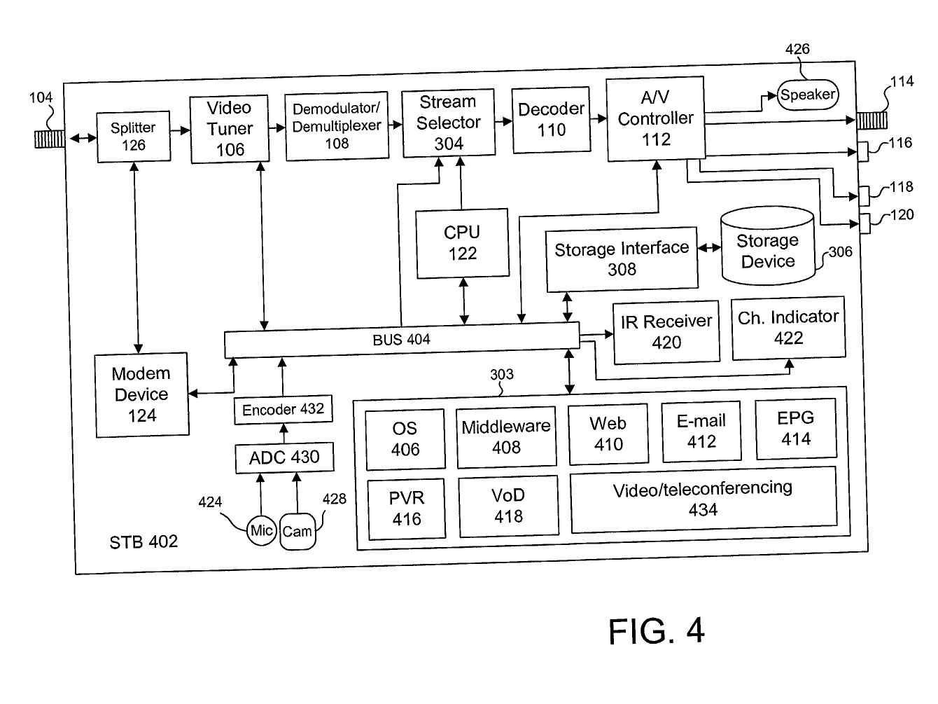

Referring to FIG. 4, an alternative embodiment of an STB 402 in accordance with the present invention is shown. The STB 402 includes a bus 404 to provide electronic communication between various components of the STB 402. One of skill in the art will appreciate that various methods for interconnecting components of the present invention are possible and would be included within the scope of the invention.

As in the prior embodiment, the STB 402 includes a stream selector 304 for selecting between media streams received from different sources, such as cable and IP sources 206,208, for decoding by the hardware decoder 110. In the depicted embodiment, inputs of the stream selector 304 are coupled to the demodulator/demultiplexer 108, the CPU 122, and the bus 404.

In the illustrated embodiment, the memory 303 includes an operating system (O/S) 406, such as, such as Linux® or Windows CE®, which manages and provides system resources to the other software modules described herein. The OS 406 preferably includes code for displaying a graphical user interface (GUI) to facilitate interaction with a user.

The memory 303 may include various combinations of volatile memory, such as random access memory (RAM), and non-volatile memory, such as read-only memory (ROM). For example, certain software modules may be loaded from the storage device 306 into RAM, while other software modules are preloaded into a flash programmable ROM.

Additionally, the memory 303 may include middleware 408, such as Liberate®, to facilitate seamless interaction between the software modules described below. The Liberate® platform combines Internet content standards such as HTML (HyperText Markup Language), JavaScript, and Java with digital television standards, including DVB and ATSC. Additionally, Liberate® integrates TV-based applications such as Electronic Program Guides (EPGs) and Video-on-Demand (VoD).

In one embodiment, the memory 303 further includes a Web module 410, such as a Web browser, for providing access to the World Wide Web (WWW) component of the Internet. Various Web modules 410 may be used, examples of which include Microsoft Internet Explorer®, Netscape Navigator®, and the like. Web browsers rely on HTTP (HyperText Transfer Protocol) and other standard protocols to retrieve and display content hosted on Internet-based servers.

Similarly, the memory 303 may include an e-mail module 412, such as Microsoft Outlook® or Eudora®. The e-mail module 412 allows a user of the STB 402 to send and receive e-mail messages using standard e-mail protocols, such as SMTP (Simple Mail Transfer Protocol), IMAP (Internet Message Access Protocol), and/or POP (Post Office Protocol).

In one embodiment, the memory 303 includes an electronic programming guide (EPG) module 414. An EPG is a listing of television programs available via cable television network for a period of time and is typically arranged in a grid configuration with axes corresponding to channels and time slots. Programming information for the EPG may be retrieved by the EPG module 414 from the cable television network or the Internet using the modem device 124. Techniques for generating an EPG are well known in the art, an example of which is shown in U.S. Pat. No. 5,532,754, for “Background Television Schedule System,” which is incorporated herein by reference.

As noted above, the STB 402 includes a storage device 306 for storing digital media streams. In one embodiment, the memory 303 includes a personal video recording (PVR) module 416 for providing PVR functionality, such as scheduled recording of television programs (e.g., digital media streams), automatic recording of television programs based on specified and observed user preferences, and pausing (buffering) live video. The PVR module 416 is also responsible for retrieving a user-selected digital media stream from the storage device 306 for decoding and presentation to the user.

A number of PVR systems are known in the art, such as TiVo® and ReplayTV®. Preferably, the PVR module 416 is seamlessly integrated with the EPG module 414, such that a user may select a television program from the EPG for scheduled recording by the PVR module 416.

In various embodiments, the memory 303 may include a Video-on-Demand (VoD) module 418 for receiving VoD programming. VoD is an umbrella term for a wide set of technologies with a common goal of enabling individuals to select videos from a central server for viewing on a television or computer screen. VoD can be used for entertainment (ordering movies transmitted digitally), education (viewing training videos), and videoconferencing (enhancing presentations with video clips). Digital video streams may be compressed using standard protocols, such as MPEG-2, and broadcast using various infrastructures, such as a broadband cable television network, a satellite (DSS) network, or the like.

Of course, various other software modules may be included within the memory 303 for providing additional features and functionality. In alternative embodiments, any of the above-described software modules may be implemented in hardware and firmware.

In the depicted embodiment, the STB 402 also includes an IR receiver 420 for receiving IR command signals from a remote control device (not shown). The companion STB 402 may further include a channel indicator 422 to indicate the currently selected channel.

In certain configurations, STB 402 includes a microphone 424, speaker 426, and/or video camera 428 to facilitate teleconferencing and/or videoconferencing. For example, the microphone 424 may capture an audio signal and transmit the same via the modem device 124 to a similarly-equipped user at a different location. Likewise, the STB 402 may receive an audio signal from another user and reproduce the signal on a television and/or the speaker 426.

The camera 428 may be embodied as a color or monochromatic digital video camera, which includes a charged coupled device (CCD) array to deliver digital video of up to, or greater than, 320×240 pixels in 24-bit color, with 30 frames per second (NTSC) or 25 frames per second (PAL). Furthermore, the camera 428 may include an optical or digital zoom, as well as automatic white balance and automatic exposure features to adjust for lighting and scene content.

The camera 428 may also be used to capture still pictures. Such still pictures may be stored in JPEG, TIFF, GIF, or other standard image formats.

The resolution of the camera 428 when used to capture still pictures may be greater than the resolution of captured video. Still pictures may be stored in the storage device 306 or sent via the modem device 124 to users equipped to view the same.

In one embodiment, video and audio signals captured by the camera 428 and microphone 424, respectively, are digitized by an ADC 430 and converted into a digital media stream by an encoder 432, such as an MPEG-2 encoder. The digital media stream may then be sent via the modem device 124 to a remote destination or stored within the storage device 306. Likewise, digital media streams received by the modem device 124 may be decoded by the decoder 110 before storage in the storage device 306 or processing and output by the A/V controller 112.

In order to facilitate video/teleconferencing, the memory 303 may include a video/teleconferencing module 434. A number of video/teleconferencing systems are known in the art, such as Microsoft NetmeeTing®, CUseeMe®, and the like. The video/teleconferencing module 434 may rely on various standard protocols, such as VoIP (Voice over IP) and MPEG to send and receive digital media streams via the modem device 124. For example, audio and video signals captured by the STB 402 may be encoded by the video/teleconferencing module 434 using the MPEG format before being sent as digital media streams via the modem device 124. Likewise, digital media streams received via the modem device 124 may be decoded by the video/teleconferencing module 434 for presentation to a user.

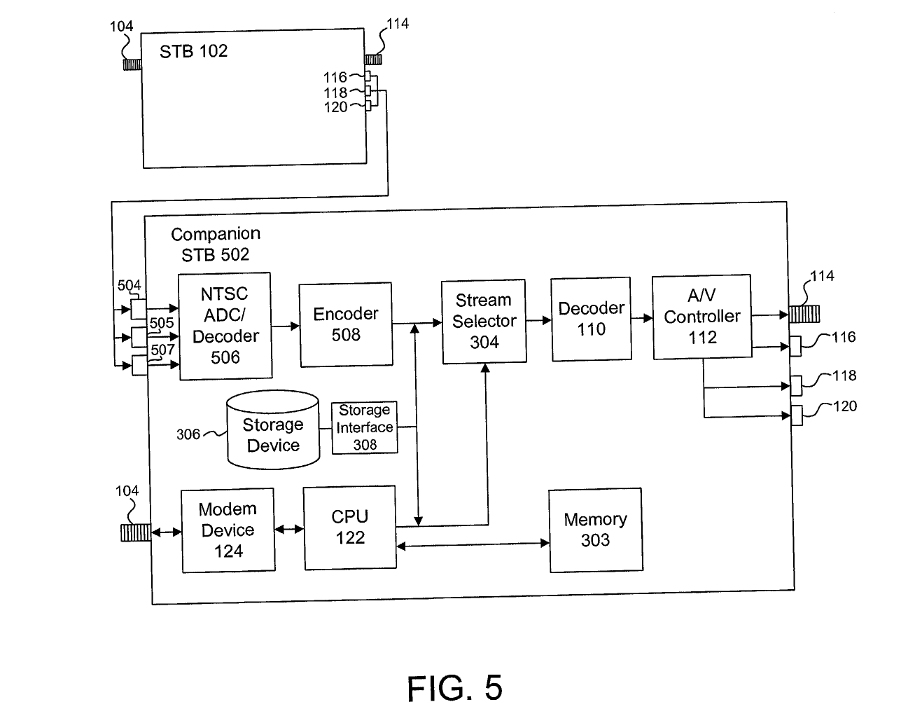

FIG. 5 illustrates another embodiment of the invention, in which a standard STB 102 interfaces with a “companion” STB 502. The companion STB 502 is used, in one embodiment, to provide Internet access and other advanced features without replacing the standard STB 102. The companion STB 402 may rely on the tuner 106 and conditional access features of the standard STB 102.

In one embodiment, video and audio outputs 116,118,120 of the standard STB 102 are coupled to video and audio inputs 504, 505, 507 of the companion STB 502. In one implementation, NTSC ADC/decoder 506 converts an analog audio/video signal received from the standard STB 102 via the inputs 504, 505, 507 into a digital signal. The companion STB 502 may also include an encoder 508, such as an MPEG-2 encoder, for encoding the digital signal into a digital media stream.

The companion STB 502 may further include a modem device 124 for receiving and demodulating a signal including a digital media stream from an IP source 208. The modem device 124 is in communication with a CPU 122, which manages network communication.

As in FIGS. 3 and 4, the STB 502 includes a stream selector 304 for selecting between encoded media streams received from multiple sources, e.g. a cable television source 206 (via the standard STB 102) and an IP source 208 (via the modem device 124), for decoding by the decoder 110. Thus, the companion STB 502 is capable of decoding IP-based media streams in hardware, resulting in improved frame rates.

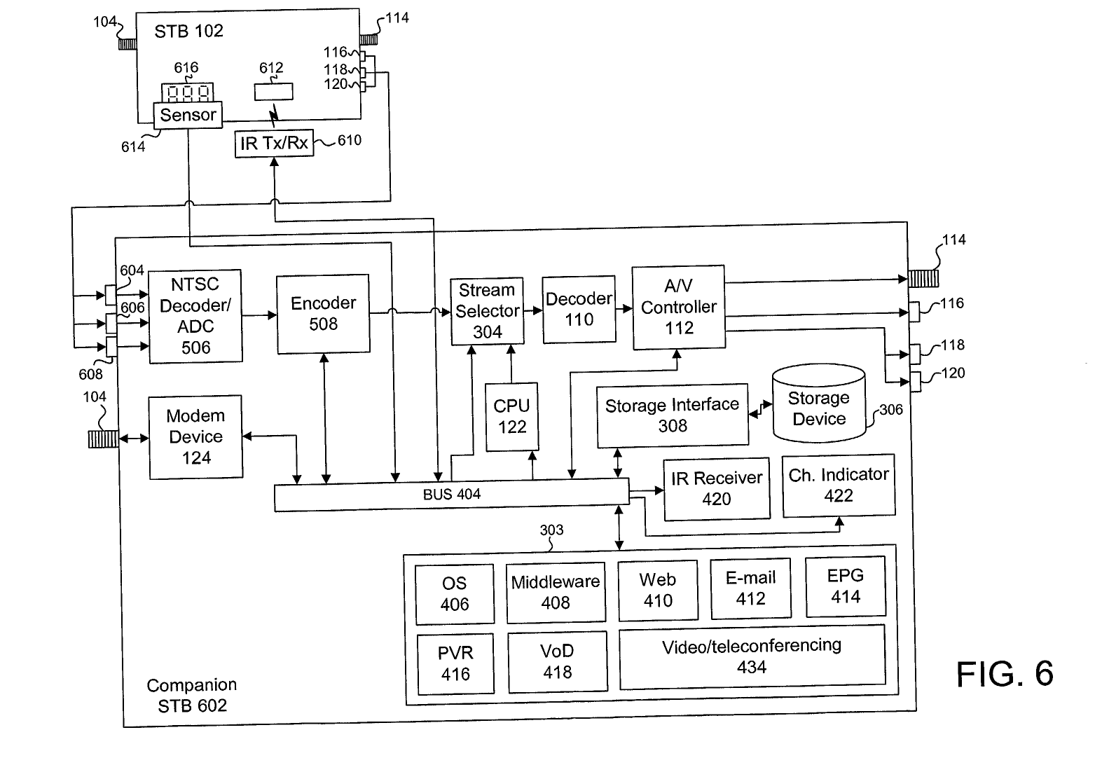

Referring to FIG. 6 an alternative embodiment of a companion STB 602 is shown in electrical communication with a standard STB 102. A composite video output 116 of the standard STB 102 is coupled to a composite video input 604 of the companion STB 602. Likewise, left and right audio outputs 118,120 of the standard STB 102 are coupled to left and right audio inputs 606, 608 of the companion STB 602. Such couplings may be easily performed by an end-user by means of conventional cabling. In alternative embodiments, the companion STB 602 may include other types of inputs, such as an S-Video input or an SPDIF input, for coupling the companion STB 602 to the standard STB 102.

In one implementation, the companion STB 602 is also in communication with the standard STB 102 via a remote control simulator 610, such as an IR Blaster™, available from Sunbelt Industries Technologies Group, Inc. An IR Blaster™ includes an infrared (IR) transmitter that simulates a remote control device by generating IR commands for reception by an IR receiver 612 of the standard STB 102. The remote control simulator 610 may be attached via a wire to the companion STB 102, allowing it to be placed in close proximity to an IR receiver 612.

In operation, the remote control simulator 610 receives electrical signals from the companion STB 602 and generates corresponding IR commands for reception by the IR receiver 612. Using the remote control simulator 610, for example, the companion STB 602 may instruct the standard STB 102 to change channels, order pay-per-view (PPV) programming, or to perform any other function that may be accessed by a remote control device for the standard STB 102. Thus, only a single remote control device may be required for operating both the companion STB 602 and the standard STB 102.

The remote control simulator 610 may also include an IR receiver configured to receive IR signals from the remote control device in order to “learn” which IR signals correspond to various commands. Mappings between IR signals and commands may be stored in a memory 303 of the companion STB 602 or of the remote control simulator 610, itself. Of course, a basic set of commands may be pre-programmed for the particular type of standard STB 102 in operation.

The use of a remote control simulator 610 provides the companion STB 602 with effective control over the standard STB 102, without requiring expensive upgrades or retrofits. One advantage of the present invention is that an end-user may easily interface the companion STB 602 with the standard STB 102 without the assistance of a cable television technician or the need to modify the standard STB 102 in any manner.

The STB 602 may further include an external sensor 614 for reading or detecting a change in a channel indicator 616 of the standard STB 102. One of the difficulties with standard remote control simulators 610, such as the IR Blaster™, is that, for various reasons, an IR command may not be successfully transmitted to the standard STB 102. Unfortunately, if the companion STB 602 incorrectly assumes, for example, that the standard STB 102 has changed channels, the STB 602 could record the wrong programming.

In one embodiment, the sensor 614 provides a feedback mechanism to indicate to the companion STB 602 which channel is being displayed by the standard STB 102, or at least whether a channel change has occurred. Accordingly, the companion STB 602 may retransmit an IR command to the standard STB 102 the original command was not successfully received.

In one configuration, the sensor 614 is placed by an end-user over the channel indicator 616 of the standard STB 102. The sensor 614 preferably includes an array of photo-sensitive elements, allowing it to read the channel displayed by the channel indicator 616. Alternatively, the sensor 614 may be configured to determine merely whether the channel has been changed. In one embodiment, this is accomplished by detecting a change in luminosity over the entire channel indicator 616 or one or more segments thereof.

In an alternative embodiment, the companion STB 602 may be configured to detect a channel change (or the current channel) based upon information encoded within the vertical blanking interval (VBI) of the television signal received from the standard STB 102. In still other embodiments, the companion STB 602 may be configured to detect a channel change from information encoded within a digital media stream.

The companion STB 602 includes an NTSC decoder/ADC 506, coupled to the inputs 604, 606, 608, which decodes a composite television signal received from the standard STB 102 and converts the same into a digital signal using techniques well known in the art. Outside of the United States, a PAL or SECAM decoder may be provided.

As in the embodiment of FIG. 5, the companion STB 602 may also include an encoder 508 for converting the digital signal into a digital media stream. The STB 602 may further include a bus 404, similar to that of the embodiment of FIG. 4, to provide communication between various components. A received cable television digital media stream may be sent via the bus 404 to the storage device 306 to enable advanced features such as those previously described.

As with previous embodiments, IP-based media streams are received through the RF input 104 and the modem device 124. Received IP packets are sent through the bus 404 to the CPU 122 where they are processed to generate a media stream. The companion STB 602 includes a stream selector 304 to select between media streams from multiple sources, such as cable television and IP sources 206, 208. The CPU 122 may signal the stream selector 304 to control selection of media streams in response to user commands.

Stored media streams may be retrieved from the storage device 306 and sent via the bus 404 to the stream selector 304 and outputted to the decoder 110. The decoder 110 then decodes the digital media stream into a signal compatible with the AN controller 112. Other components illustrated in the embodiment of FIG. 6 are similar to those previously described. Although the embodiment of FIG. 6 does not specifically illustrate a microphone, camera, or speaker as in the embodiment of FIG. 4, one of skill in the art will appreciate that such components may be by included.

The embodiments of FIGS. 5 and 6 illustrate the use of a companion STB 502, 602 that relies upon the video tuner of a standard STB for tuning to a selected channel. Thus, a companion STB 502, 602 need not include a video tuner of its own. In addition, a companion STB 502, 602 may include a stream selector 304 to enable hardware decoding of digital media streams from alternative sources.

Various embodiments of the present invention include a stream selector 304 to accommodate both cable television and IP-based streams. In this manner, a hardware decoder 110 may be utilized to decode IP-based streams rather than relying on the CPU 122 for software decoding. This provides higher frame rates and reduces the processing burden on the CPU 122.

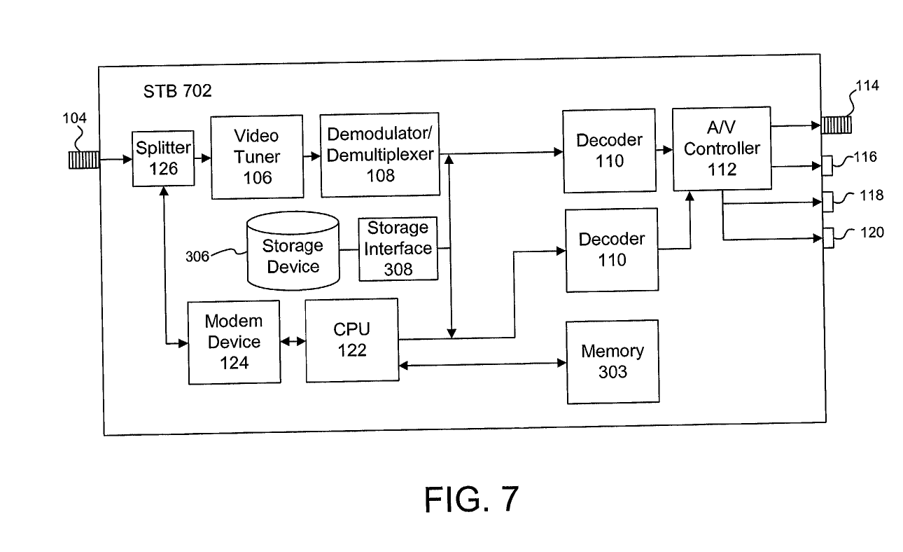

In an alternative embodiment, as shown in FIG. 7, an STB 702 may include a plurality of hardware decoders 110. For example, separate hardware decoders 110 may be provided for decoding media streams from cable television and IP sources 206, 208. This is advantageous in embodiments in which a TV screen may contain a window with broadcast video, IP streaming video, and videoconferencing, which could involve the simultaneous decoding of MPEG-2, MPEG-4 and H.263 streams.

The decoders 110 illustrated in FIG. 7 (as well as those shown in FIGS. 1 and 3-6) may be embodied as programmable subsystems (e.g., DSPs, FPGAs). In such embodiments, customized code may be downloaded into the decoders 110 to decode various types of media streams as needed.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A set top box (STB) for decoding media streams from multiple sources, the STB comprising:
a processor;
a hardware decoder, coupled to the processor, for decoding media streams;
a first stream receiver configured to receive a media stream from a first source;
a second stream receiver configured to receive a media stream from a second source; and
a stream selector having first and second inputs and an output, the first input coupled to the first stream receiver, the second input coupled to the second stream receiver, and the output coupled to the hardware decoder, wherein the stream selector is configured to selectively direct one of the media streams to the hardware decoder under control of the processor.

2. The STB of claim 1, wherein at least one media stream comprises a Moving Picture Experts Group (MPEG) stream, and wherein the hardware decoder comprises an MPEG decoder.

3. The STB of claim 1, wherein the first stream receiver comprises a video tuner.

4. The STB of claim 3, wherein the first source comprises a cable television source.

5. The STB of claim 1, wherein the second stream receiver comprises a modem device.

6. The STB of claim 5, wherein the modem device comprises a Data Over Cable Service Interface Specification (DOCSIS) modem.

7. The STB of claim 5, wherein the second source comprises an Internet Protocol (IP) source.

8. The STB of claim 1, wherein the stream selector comprises a multiplexer having a select line coupled to the processor.

9. The STB of claim 1, further comprising:
an audio/video controller coupled to the hardware decoder for formatting media streams for presentation by an external display device; and
an output coupled to the hardware decoder for providing operable connection to the external display device.

10. The STB of claim 1, further comprising a storage device, coupled to the processor, for storing at least one media stream.

11. A method in a set top box (STB) for decoding media streams from multiple sources, the STB comprising a hardware decoder and a processor, the method comprising:
receiving a first media stream from a first source;
receiving a second media stream from a second source;
using a stream selector, under control of the processor, to selectively direct one of the media streams to the hardware decoder for decoding.

12. The method of claim 11, wherein at least one media stream comprises a Moving Picture Experts Group (MPEG) stream, and wherein the hardware decoder comprises an MPEG decoder.

13. The method of claim 11, wherein the first media stream is received by a video tuner within the STB.

14. The method of claim 13, wherein the first source comprises a cable television source.

15. The method of claim 11, wherein the second media stream is received by a modem device within the STB.

16. The method of claim 15, wherein the modem device comprises a Data Over Cable Service Interface Specification (DOCSIS) modem.

17. The method of claim 15, wherein the second source comprises an Internet Protocol (IP) source.

18. The method of claim 11, wherein the stream selector comprises a multiplexer having a select line coupled to the processor.

19. The method of claim 11, further comprising formatting the selected media stream for presentation by an external display device.

20. The method of claim 11, further comprising storing at least one media stream in a storage device within the STB.

21. A companion device for enhancing a set top box for an entertainment system, the companion device comprising:
a processor;
a hardware decoder, coupled to the processor, for decoding media streams;
a first stream receiver, coupled to the set top box, for receiving a media stream therefrom;
a second stream receiver for receiving a media stream from an alternative source; and
a stream selector having first and second inputs and an output, the first input coupled to the first stream receiver, the second input coupled to the second stream receiver, and the output coupled to the hardware decoder, wherein the stream selector is configured to selectively direct one of the media streams to the hardware decoder under control of the processor.

22. The companion device of claim 21, wherein at least one media stream comprises a Moving Picture Experts Group (MPEG) stream, and wherein the hardware decoder comprises an MPEG decoder.

23. The companion device of claim 21, wherein the first stream receiver comprises a video tuner.

24. The companion device of claim 21, wherein the second stream receiver comprises a modem device.

25. The companion device of claim 24, wherein the modem device comprises a Data Over Cable Service Interface Specification (DOCSIS) modem.

26. The companion device of claim 24, wherein the second source comprises an Internet Protocol (IP) source.

27. The companion device of claim 21, wherein the stream selector comprises a multiplexer having a select line coupled to the processor.

28. The companion device of claim 21, further comprising:
an audio/video controller coupled to the hardware decoder for formatting media streams for presentation by an external display device; and
an output coupled to the hardware decoder for providing operable connection to the external display device.

29. The companion device of claim 21, further comprising a storage device, coupled to the processor, for storing at least one media stream.

30. A set top box (STB) for decoding media streams from multiple sources, the STB comprising:
processing means;
means, coupled to the processing means, for decoding media streams;
means for receiving a media stream from a first source;
means for receiving a media stream from a second source; and
stream selection means having first and second inputs and an output, the first input coupled to the means for receiving a media stream from the first source, the second input coupled to the means for receiving a media stream from a second source, and the output coupled to the decoding means, wherein the stream selection means are configured to selectively direct one of the media streams to the decoding means under control of the processing means.

31. A multimedia communications apparatus comprising:
a receiver for receiving a video signal and a streaming media signal from a multimedia communications network;
a first processing path coupled to the receiving device for tuning to the video signal;
a second processing path coupled to the receiving device for demodulating the streaming media signal;
a selector for selecting between an output of the first processing path and an output of the second processing path; and
a decoder for decoding selected output from the selector.

32. The multimedia communications apparatus of claim 31, wherein the receiver comprises a radio-frequency input coupled to a splitter, and the splitter comprises a first output coupled to the first processing path and a second output coupled to the second processing path.

33. The multimedia communications apparatus of claim 31, wherein the first processing path comprises a video tuner coupled to the first output of the splitter, and wherein the second processing path comprises a modem device coupled to the second output of the splitter.

34. The multimedia communications apparatus of claim 31, wherein the decoder comprises a hardware-based decoder.

35. The multimedia communications apparatus of claim 31, wherein the video and streaming media signals are both encoded using a same technique, and wherein the decoder includes capability to decode signals encoded using the same technique.

36. The multimedia communications apparatus of claim 35, wherein the same technique comprises an MPEG encoding technique.

37. The multimedia communications apparatus of claim 35, wherein the same technique comprises a Digicypher encoding technique.

38. The multimedia communications apparatus of claim 31, wherein the receiver is integrated with a set top box.

39. The multimedia communications apparatus of claim 31, wherein the receiver is integrated with a television set.

40. A multimedia communications apparatus comprising:
a receiver for receiving a video signal and a streaming media signal from a multimedia communications network;
a first processing path coupled to the receiving device for tuning to the video signal;
a second processing path coupled to the receiving device for demodulating the streaming media signal;
a first decoder for decoding output from the first processing path; and
a second decoder for decoding output from the second processing path.

41. The multimedia communications apparatus of claim 40, wherein the first and second decoders comprise hardware-based decoders.
